(19) United States
(12) Patent Application Publication
(10) Pub. No.: US 2010/0116172 A1
(43) Pub. Date: May 13, 2010

(54) METHOD FOR MAKING A DISPERSION

(75) Inventors: Jimmie R. Baran, JR., Prescott, WI (US); George W. Buckley, North Oaks, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/617,034

(22) Filed: Nov. 12, 2009

Related U.S. Application Data
(60) Provisional application No. 61/114,122, filed on Nov. 13, 2008.

(51) Int. Cl. C08L 95/00

(52) U.S. Cl. 106/277

(57) ABSTRACT

The present disclosure relates a method of making a dispersion. Microparticles, nanoparticles and an asphalt component are mixed to form a dispersion. A sufficient amount of nanoparticles provides for an increase in material throughput relative to a comparable dispersion that is free of nanoparticles.

### CROSS REFERENCE TO RELATED APPLICATION

This application claims the benefit of U.S. Provisional Patent Application No. 61/114,122 filed Nov. 13, 2008, the disclosure of which is incorporated by reference herein in its entirety.

### FIELD

The present invention discloses a method for making a dispersion and increasing material throughput of a dispersion.

### BACKGROUND

Achieving a uniform blend of particles in a resin is a problem faced daily by engineers and operators in many industries. Even when an acceptable blend is obtained, additional challenges arise in maintaining the blend through downstream equipment. Poor blending or the inability to maintain an adequate blend before and during processing typically lead to additional and unnecessary costs (e.g., costs associated with rejected material and decreased yields, added blending time and energy, decreased productivities, start-up delays and defective or out-of-specification products).

Asphalt compounds have use in a wide variety of applications including, for example, the formation of roof sheeting or roofing shingles. Asphalt roof sheeting is typically applied as a single ply roofing membrane for industrial and commercial flat roofs. Asphalt shingles are typically applied to steep slope roofs, for example residential roofs. These membranes are usually processed into sheeting rolls and applied to roofs in long strips. In such applications, the asphalt generally includes filler, for example calcium carbonate. In some applications, the asphalt compound includes up to 70% filler.

### SUMMARY

The present disclosure provides a method for making a dispersion which comprises mixing microparticles, nanoparticles and an asphalt component.

Particles (e.g., fillers and extenders) and/or small molecules may present problems in asphalt compound coatings. The particles or small molecules may migrate to the surface, or may be poorly dispersed when mixed to yield regions of disproportionate or discontinuous concentrations resulting in negative and/or undesirable properties. During the mixing of fluids or liquids with particles, inconsistencies in mixing viscosities, torque, and material throughput may be encountered as a result of immiscible compositions and/or poor dispersions of particles.

Microparticles and nanoparticles are mixed in an asphalt component to form a more homogeneous dispersion having increased material throughput and decreased mixing time. In some instances, it would be possible to increase the amount of microparticles in the dispersion, thus producing a more highly loaded dispersion. A coating comprising the dispersion with a sufficient amount of nanoparticles has increased material throughput and decreased mixing time relative to a comparable coating comprising a dispersion that is free of nanoparticles.

### DETAILED DESCRIPTION

For the following defined terms, these definitions shall be applied, unless a different definition is given in the claims or elsewhere in the specification.

The term “material throughput” refers to the amount of a dispersion produced by a mixing process that mixes microparticles, nanoparticles and an asphalt component over a set period of time (recorded in grams/minute) to make a dispersion. The output of the inventive process is compared to that of a similar process without nanoparticles, but essentially the same in all other respects, such as type of apparatus used and process conditions (e.g., temperature).

The term “mixing time” refers to the time required to mix nanoparticles, microparticles, and an asphalt component to make a dispersion.

The term “amount sufficient” refers to a quantity of nanoparticles that are present in the dispersion to affect material properties relative to a comparable dispersion that is free of nanoparticles. For example, the property may be increased or decreased as a function of the quantity or amount of a material. For example, the nanoparticles mixed in the dispersion provide an increase in material throughput, and/or a decrease in mixing time.

The term “comparable dispersion” refers to a dispersion of nanoparticles which, by comparison to a dispersion of this invention is the same, except for the absence of nanoparticles. A comparable dispersion comprises microparticles and a fluid medium, where the concentration of microparticles remains constant with respect to the asphalt component.

A “more homogeneous dispersion” refers to a dispersion of microparticles with nanoparticles which has a smoother appearance and consistency as compared to a dispersion of the microparticles without the nanoparticles.

The term “more highly loaded dispersion” refers to a dispersion containing more microparticles (by weight or volume) with nanoparticles than a dispersion made without the nanoparticles.

The term “asphalt component” refers to asphalt (bitumen) in liquid fluid form capable of dispersing particles, e.g., microparticles and nanoparticles. The particles are independently dispersed with mixing in the asphalt component, or the microparticles and nanoparticles are mixed together prior to dispersing in the asphalt component.

The term “nanoparticle” as used herein (unless an individual context specifically implies otherwise) will generally refer to particles, groups of particles, particulate molecules such as small individual groups or loosely associated groups of molecules, and groups of particulate molecules that while potentially varied in specific geometric shape have an effective, or median, diameter that can be measured on a nanoscale (less than 100 nanometers), and more preferably having an effective, or median, diameter or particle size less than 50 nm.

The recitation of numerical ranges by endpoints includes all numbers subsumed within that range (e.g., 1 to 5 includes 1, 1.5, 2, 2.75, 3, 3.8, 4, and 5).

As included in this specification and the appended claims, the singular forms “a”, “an”, and “the” include plural referents unless the content clearly dictates otherwise. Thus, for example, reference to a composition containing “a compound” includes a mixture of two or more compounds. As used in this specification and appended claims, the term “or” is generally employed in its sense including “and/or” unless the content clearly dictates otherwise.

Unless otherwise indicated, all numbers expressing quantities or ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure. At the very least, and not as an attempt to limit the application of the doctrine of equivalents to the scope of the claims, each numerical parameter should at least be construed in light of the number of reported significant digits and by applying ordinary rounding techniques. Not withstanding that the numerical ranges and parameters setting forth the broad scope of the disclosure are approximations, their numerical values set forth in the specific examples are reported as precisely as possible. Any numerical value, however, inherently contains errors necessarily resulting from the standard deviations found in their respective testing measurement.

A method for making a dispersion comprises mixing microparticles, nanoparticles and an asphalt component. The nanoparticles are added to increase the homogeneity of the dispersion, increase the material throughput and decrease the mixing time required for making a dispersion relative to a comparable dispersion that is free of nanoparticles. The nanoparticles can also be added to increase the weight (volume) of the microparticles in the dispersion. Typically, the nanoparticles reduce the amount of agglomeration and flocculation present in the microparticles.

Microparticles generally include inorganic microparticles. Generally, the microparticles will have a median particle size or diameter greater than 0.5 micrometers. The microparticles may be further distinguished from the nanoparticles of this disclosure by relative size or median particle size or diameter, shape, and/or functionalization within or on the surface, wherein the microparticles are typically larger than the nanoparticles.

Examples of inorganic microparticles include metals, ceramics (including beads, bubbles, microspheres and aerogels), fillers (e.g., carbon black, titanium dioxide, calcium carbonate, dicalcium phosphate, nepheline (available under the tradename designation, “MINEX” (Unimin Corporation, New Canaan, Conn.), feldspar and wollastonite), excipients, silicates (e.g., talc, clay, and sericite), aluminates and combinations thereof.

Exemplary ceramic microparticles can be made using techniques known in the art and/or are commercially available. Ceramic bubbles and ceramic microspheres are described, for example, in U.S. Pat. No. 4,767,726 (Marshall) and U.S. Pat. No. 5,883,029 (Castle). Examples of commercially available glass bubbles include those marketed by 3M Company, St. Paul, Minn., under the designation “3M SCOTCHLITE GLASS BUBBLES” (e.g., grades K1, K15, S15, S22, K20, K25, S32, K37, S38, K46, S60/10000, S60HS, A16/500, A20/1000, A20/1000, A20/1000, A20/1000, H50/10000 EPX, and H50/10000 (acid washed)); glass bubbles marketed by Potter Industries, Valley Forge, Pa., under the trade designation “SPHERICEL” (e.g., grades 110P8 and 60P18), “LUXSIL”, and “Q-CEL” (e.g., grades 30, 6014, 6019, 6028, 6036, 6042, 6048, 5019, 5023, and 5028); hollow glass microspheres marketed under the trade designation “DICAPERL” by Grefco Minerals, Bala Cynwyd, Pa., (e.g., grades HP-820, HP-720, HP-520, HP-220, HP-120, HP-900, HP-920, CS-10-400, CS-10-200, CS-10-125, CSM-10-300, and CSM-10-150); and hollow glass particles marketed by Silbrico Corp., Hodgkins, Ill., under the trade designation “SIL-CELL” (e.g., grades SIL 35/34, SIL-32, SIL-42, and SIL-43). Commercially available ceramic microspheres include ceramic hollow microspheres marketed by SphereOne, Inc., Silver Plume, Colo., under the trade designation, “EXTENDOSPHERES” (e.g., grades SG, CG, TG, SF-10, SF-12, SF-14, SLG, SL-90, SL-150, and XOL-200); and ceramic microspheres marketed by 3M Company under the trade designation “3M CERAMIC MICROSPHERES” (e.g., grades G-200, G-400, G-600, G-800, G-850, W-210, W-410, and W-610).

Commonly used fillers include aggregated forms of silica, such as fumed or precipitated silica. Such aggregated silicas consist of small diameter particles firmly aggregated with one another into an irregular network. These aggregates require high shear to be broken, and even when subjected to high shear forces, the aggregate is typically not broken down into individual particles. Similarly, surface treated silica, after being exposed to high shear forces, yields new untreated particle surfaces which may affect the particle solubility/dispersibility into an asphalt component.

Another commonly used filler is calcium carbonate which is can be used as a filler in place of a more expensive materials such as titania or other such pigments or inorganic materials.

Materials like calcium carbonate can also be used to extend more expensive materials such as asphalt.

In one embodiment, the microparticles are at least one of silicates, calcium carbonate, ceramic beads, ceramic bubbles, or ceramic microspheres.

Generally, the microparticles will have median particle size diameters greater than 0.5 micrometer and more desirably greater than 5 micrometers. In some instances, the microparticles may have median particle size diameters greater than 25 micrometers with some median particle size diameters greater than 100 micrometers, but larger than the surface modified nanoparticles. In one embodiment, the microparticles may have median particle size diameters ranging from 0.5 micrometer to 200 micrometers, preferably ranging from 1 micrometer to 100 micrometers, and more preferably ranging from 5 micrometers to 50 micrometers, based on the median particle size diameter, but not limited to the microparticles in the ranges specified. Some of the microparticles may have a distribution of microparticle sizes, wherein a majority of the microparticles may fall within the ranges specified. Some of the microparticles may have median particle size diameters outside of the microparticle distribution.

In some embodiments, the microparticles are the same (e.g., in terms of size, shape, composition, microstructure, surface characteristics, etc.); while in other embodiments they are different. In some embodiments, the microparticles may have a modal (e.g., bi-modal or tri-modal) distribution. In another aspect, more than one type of microparticle(s) may be used. A combination of organic and/or inorganic microparticles may be used. It will be understood that the microparticles may be used alone or in combination with one or more other microparticles including mixtures and combinations of organic and inorganic microparticles with nanoparticles and an asphalt component in a dispersion.

The nanoparticles described in this disclosure may be nonsurface modified nanoparticles, surface modified nanoparticles or mixtures and combinations of each. Surface modified nanoparticles are physically or chemically modified that is different from the composition of the bulk of the nanoparticles. The surface groups of the nanoparticle preferably are present in an amount sufficient to form a monolayer, preferably a continuous monolayer, on the surface of the particle. The surface groups are present on the surface of the nanoparticles in an amount sufficient to provide nanoparticles that are capable of being subsequently mixed with microparticles and an asphalt component with minimal aggregation or agglomeration.

The nanoparticles are present in the dispersion in an amount sufficient to increase material throughput and decrease mixing time of the dispersion.

Suitable inorganic nanoparticles include calcium phosphate, calcium hydroxyapatite, calcium carbonate and metal oxide nanoparticles such as zirconia, titania, silica, ceria, alumina, iron oxide, vanadia, zinc oxide, antimony oxide, tin oxide, nickel oxide, and combinations thereof. Suitable inorganic composite nanoparticles include alumina/silica, iron oxide/titania, titania/zinc oxide, zirconia/silica, and combinations thereof. Metals such as gold, silver, or other precious metals can also be utilized as solid particles or as coatings on organic or inorganic nanoparticles.

In one embodiment, the nanoparticles are one of at least silica, alumina, or titania.

Surface modified nanoparticles or precursors to them may be in the form of a colloidal dispersion. Some of these dispersions are commercially available as unmodified silica starting materials, for example, those nano-sized colloidal silicas available under the product designations “NALCO 1040,” “NALCO 1050,” “NALCO 1060,” “NALCO 2326,” “NALCO 2327,” and “NALCO 2329” colloidal silica from Nalco Chemical Co. of Naperville, Ill. Metal oxide colloidal dispersions include colloidal zirconium oxide, suitable examples of which are described, for example, in U.S. Pat. No. 5,037,579 (Matchett), and colloidal titanium oxide, examples of which are described, for example, in U.S. Pat. Nos. 6,329,058 and 6,432,526 (Arney et al.). Such nanoparticles are suitable substrates for surface modification as described below.

It will be understood that the selected surface modified nanoparticles may be used alone or in combination with one or more other nanoparticles including mixtures and combinations of organic and inorganic nanoparticles. Such combinations may be uniform or have distinct phases, which can be dispersed or regionally specific, such as layered or of a core-shell type structure. The selected nanoparticles, whether inorganic or organic, and in whatever form employed, will generally have a median particle diameter of less than 100 nanometers. In some embodiments, nanoparticles may be utilized having a smaller median effective particle diameter of, for example less than or equal to 50, 40, 30, 20, 15, 10 or 5 nanometers; in some embodiments from 2 nanometers to 20 nanometers; in still other embodiments from 3 nanometers to 10 nanometers. If the chosen nanoparticle or combinations of nanoparticles are themselves aggregated, the maximum preferred cross-sectional dimension of the aggregated nanoparticles will be within any of these stated ranges.

In many cases it may be desirable for the nanoparticles utilized to be substantially spherical in shape. In other applications, however, more elongated shapes by be desired. Aspect ratios less than or equal to 10 are considered preferred, with aspect ratios less than or equal to 3 generally more preferred.

Surface modified or unmodified nanoparticles may be selected such that the nanoparticles are essentially free from a degree of particle association, agglomeration, or aggregation that may interfere with the desired properties when mixed with a microparticles and an asphalt component of a dispersion. As used herein, particle “association” is defined as a reversible chemical combination due to any of the weaker classes of chemical bonding forces. Examples of particle association include hydrogen bonding, electrostatic attraction, London forces, van der Waals forces, and hydrophobic interactions. As used herein, the term “agglomeration” is defined as a combination of molecules or colloidal particles into clusters. Agglomeration may occur due to the neutralization of the electric charges, and is typically reversible. As used herein, the term “aggregation” is defined as the tendency of large molecules or colloidal particles to combine in clusters or clumps and precipitate or separate from the dissolved state. Aggregated nanoparticles are firmly associated with one another, and require high shear to be broken. Agglomerated and associated particles can generally be easily separated.

In one embodiment, surface-modified nanoparticles comprise a nanoparticle(s) with a modified surface. The nanoparticles may be inorganic or organic and are selected such that, as described in more detail herein, it is compatible with the microparticles with which it is mixed in an asphalt component and is suitable for the application for which it is intended. Generally, the selection of the nanoparticles will be governed at least in part by the specific performance requirements for the dispersion and any more general requirements for the intended application. For example, the performance requirements for the solid or liquid dispersion might require that a nanoparticle have certain dimensional characteristics (size and shape), compatibility with the surface modifying materials along with certain stability requirements (insolubility in a processing or mixing solvent). Further requirements might be prescribed by the intended use or application of the dispersion. Such requirements might include biocompatibility or stability under more extreme environments, such as high temperatures.

The surface of the selected nanoparticles will be chemically or physically modified in some manner. Such modifications to the nanoparticle surface may include, for example, covalent chemical bonding, hydrogen bonding, electrostatic attraction, London forces and hydrophilic or hydrophobic interactions so long as the interaction is maintained at least during the time period required for the nanoparticles to achieve their intended utility. The surface of a nanoparticle may be modified with one or more surface modifying groups. The surface modifying groups may be derived from a myriad of surface modifying agents. Schematically, surface modifying agents may be represented by the following general formula:

A-B (I)

The A group in Formula I is a group or moiety that is capable of attaching to the surface of the nanoparticle. In those situations where the nanoparticle is processed in solvent, the B group is a compatibilizing group with whatever solvent is used to process the nanoparticles. In those situations where the nanoparticles are not processed in solvent, the B group is a group or moiety that is capable of preventing irreversible agglomeration of the nanoparticles. It is possible for the A and B components to be the same, where the attaching group may also be capable of providing the desired surface compatibility. The compatibilizing group may be reactive, but is generally non-reactive, with the microparticles. It is understood that the attaching composition may be comprised of more than one component or created in more than one step, e.g., the A composition may be comprised of an A′ moiety which is reacted with the surface of a nanoparticle, followed by an A″ moiety which can then be reacted with B. The sequence of addition is not important, i.e., the A′A″B component reactions can be wholly or partly performed prior to attachment to the nanoparticle. Further description of nanoparticles in coatings can be found in Linsenbuhler, M. et. al., Powder Technology, 158, 2003, p. 3-20.

Many suitable classes of surface-modifying agents for modifying the nanoparticle surface are known to those skilled in the art and include silanes, organic acids, organic bases, and alcohols, and combinations thereof.

In another embodiment, surface-modifying agents include silanes. Examples of silanes include organosilanes such as alkylchlorosilanes; alkoxysilanes (e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, isooctyltrimethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri(t-butoxy)silane, vinyltris(isobutoxy)silane, vinyltris(isopropenoxy)silane, and vinyltris(2-methoxyethoxy)silane; trialkoxyarylsilanes; isooctyltrimethoxy-silane; N-(3-triethoxysilylpropyl)methoxyethoxyethoxy ethyl carbamate; N-(3-triethoxysilylpropyl) methoxyethoxyethoxyethyl carbamate; silane functional (meth)acrylates (e.g., 3-(methacryloyloxy)propyltrimethoxysilane,
3-acryloyloxypropyltrimethoxysilane, 3-(methacryloyloxy)propyltriethoxysilane,
3-(methacryloyloxy)propylmethyldimethoxysilane,
3-(acryloyloxypropyl)methyldimethoxysilane,
3-(methacryloyloxy)propyldimethylethoxysilane, 3-(methacryloyloxy)methyltriethoxysilane,
3-(methacryloyloxy)methyltrimethoxysilane, 3-(methacryloyloxy)propyldimethylethoxysilane,
3-(methacryloyloxy)propenyltrimethoxysilane, and
3-(methacryloyloxy)propyltrimethoxysilane)); polydialkylsiloxanes (e.g., polydimethylsiloxane); arylsilanes (e.g., substituted and unsubstituted arylsilanes); alkylsilanes (e.g., substituted and unsubstituted alkyl silanes (e.g., methoxy and hydroxy substituted alkyl silanes)), and combinations thereof.

In one embodiment, the surface modifying agent for the nanoparticle may be an unsubstituted alkylsilane.

In one embodiment, the surface modifying agent for the nanoparticles is isooctyltrimethoxysilane, where the nanoparticles are isooctyl functionalized silica nanoparticles after chemical modification. “Isooctyl functionalized” refers to the chemical modification of a silica nanoparticle with isooctyltrimethoxysilane as described in U.S. Pat. No. 6,586,483 (Kolb et al.).

For example, silica nanoparticles may be modified with silane functional (meth)acrylates as described, for example, in U.S. Pat. No. 4,491,508 (Olson et al.), U.S. Pat. No. 4,455,205 (Olson et al.), U.S. Pat. No. 4,478,876 (Chung), U.S. Pat. No. 4,486,504 Chung), and U.S. Pat. No. 5,258,225 (Katsamberis). Surface-modified silica nanoparticles include silica nanoparticles surface modified with silane surface modifying agents (e.g., acryloyloxypropyl trimethoxysilane, 3-methacryloyloxypropyltrimethoxysilane, 3-mercaptopropyltrimethoxysilane, n-octyltrimethoxysilane, isooctyltrimethoxysilane, and combinations thereof). Silica nanoparticles can be treated with a number of surface modifying agents (e.g., alcohol, organosilane (e.g., alkyltrichlorosilanes, trialkoxyarylsilanes, trialkoxy(alkyl)silanes, and combinations thereof), and organotitanates and mixtures thereof).

Nanoparticle surfaces may be modified with organic acid surface-modifying agents which include oxyacids of carbon (e.g., carboxylic acid), sulfur and phosphorus, acid derivatized poly(ethylene) glycols (PEGs) and combinations of any of these. Suitable phosphorus containing acids include phosphonic acids (e.g., octylphosphonic acid, laurylphosphonic acid, decylphosphonic acid, dodecylphosphonic acid, and octadecylphosphonic acid), monopolyethylene glycol phosphonate and phosphates (e.g., lauryl or stearyl phosphate). Suitable sulfur containing acids include sulfates and sulfonic acids including dodecyl sulfate and lauryl sulfonate. Any such acids may be used in either acid or salt forms.

Non-silane surface modifying agents include acrylic acid, methacrylic acid, beta-carboxyethyl acrylate, mono-2-(methacryloyloxyethyl) succinate, mono(methacryloyloxypolyethyleneglycol) succinate and combinations of one or more of such agents. In another embodiment, surface modifying agents incorporate a carboxylic acid functionality such as CH₃O(CH₂CH₂O)₂CH₂COOH, 2-(2-methoxyethoxy)acetic acid having the chemical structure CH₃OCH₂CH₂OCH₂COOH, mono(polyethylene glycol) succinate in either acid or salt form, octanoic acid, dodecanoic acid, steric acid, acrylic and oleic acid or their acidic derivatives. In a further embodiment, surface modified iron oxide nanoparticles include those modified with endogenous fatty acids (e.g., stearic acid) or fatty acid derivatives using endogenous compounds (e.g., stearoyl lactylate or sarcosineor taurine derivatives). Further, surface modified zirconia nanoparticles include a combination of oleic acid and acrylic acid adsorbed onto the surface of the particle.

Organic base surface modifying agents for nanoparticles may include alkylamines (e.g., octylamine, decylamine, dodecylamine, octadecylamine, and monopolyethylene glycol amines).

Surface-modifying alcohols and thiols may also be employed including aliphatic alcohols (e.g., octadecyl, dodecyl, lauryl and furfuryl alcohol), alicyclic alcohols (e.g., cyclohexanol), and aromatic alcohols (e.g., phenol and benzyl alcohol), and combinations thereof. Thiol-based compounds are especially suitable for modifying cores with gold surfaces.

Surface-modified nanoparticles are generally selected in such a way that dispersions formed with them are free from a degree of particle agglomeration or aggregation that would interfere with the desired properties of the dispersion or application. The surface-modified nanoparticles are generally selected to be either hydrophobic or hydrophilic such that, depending on the character of the microparticles and the asphalt component for mixing with the microparticles and nanoparticles, the resulting dispersion exhibits substantially free flowing (i.e., the ability of a material to maintain a stable, steady and uniform/consistently flow, as individual particles) properties.

Suitable surface groups constituting the surface modification of the utilized nanoparticles can thus be selected based upon the nature of the asphalt components and bulk materials used and the properties desired of the resultant dispersion, article, or application. When a processing solvent (fluid polymer component) is hydrophobic, for example, one skilled in the art can select from among various hydrophobic surface groups to achieve a surface modified particle that is compatible with the hydrophobic solvent; when the processing solvent is hydrophilic, one skilled in the art can select from various hydrophilic surface groups; and, when the solvent is a hydrofluorocarbon or fluorocarbon, one skilled in the art can select from among various compatible surface groups; and so forth. The nature of the microparticles and the other components of the dispersion in addition to the desired final properties can also affect the selection of the nanoparticle surface composition. The nanoparticles can include two or more different surface groups (e.g., a combination of hydrophilic and hydrophobic groups) that combine to provide surface modified nanoparticles having a desired set of characteristics. The surface groups will generally be selected to provide a statistically averaged, randomly surface modified particle.

The surface groups on the surface of the nanoparticle may be present in an amount sufficient to provide surface modified nanoparticles with the properties necessary for compatibility and efficient mixing with the microparticles in an asphalt component of a dispersion. Further compatibility considerations may include the use of other components for applications in coatings, inks, films, and medicaments.

A variety of methods are available for modifying the surfaces of nanoparticles. A surface modifying agent may, for example, be added to nanoparticles (e.g., in the form of a powder or a colloidal dispersion) and the surface modifying agent may be allowed to react with the nanoparticles. Multiple synthetic sequences to bring the nanoparticle together with the surface modifying group are possible. Surface modification processes are described, for example, in U.S. Pat. No. 2,801,185 (Iler), U.S. Pat. No. 4,522,958 (Das et al.) and U.S. Pat. No. 6,586,483 (Kolb et al.).

In one embodiment, the weight ratio of nanoparticles (e.g., unmodified and/or surface modified) to microparticles is at least 1:100,000. Generally, the weight ratio of nanoparticles to microparticles is at least 1:100,000 to 1:20, more preferably, the weight ratio ranges from 1:10,000 to 1:500, and more preferably, the weight ratio ranges from 1:5,000 to 1:1,000.

The mixing of the nanoparticles and microparticles in an asphalt component for making a dispersion may be accomplished via extrusion, melt mixing, solution mixing and combinations thereof. The dispersion has an increased material throughput relative to a comparable dispersion that is free of surface modified nanoparticles.

In one embodiment, the material throughput of the dispersion relative to a comparable dispersion that is free of nanoparticles is increased by at least 5% as determined by the weight of the composition after mixing as a function of time. Preferably, the material throughput is increased by at least 10%, at least 15%, at least 20%, at least 25%, at least 30%, at least 35%, at least 40%, at least 45%, or even at least 50%.

In one embodiment, the material throughput of the dispersion may be increased with the presence of a sufficient amount of nanoparticles relative to a composition that is free of nanoparticles, if under at least one identical condition (e.g., screw speed, extrusion temperature, feed rate, screw configuration). Effective mixing of the microparticles and nanoparticles and an asphalt component may decrease the mixing time of the dispersion.

The concentration of nanoparticles present in the dispersion is at least 0.00075 weight percent based on the total weight of the dispersion. Generally, the nanoparticles are present in the dispersion at a concentration ranging from at least 0.0075 to 15 weight percent, more preferably at a concentration ranging from 0.075 to 7.5 weight percent, and most preferably at a concentration ranging from 0.75 to 5 weight percent.

What is claimed is:

1. A method of making a dispersion, the method comprising:
mixing microparticles, nanoparticles and an asphalt component to form a dispersion.

2. The method of claim 1 wherein the nanoparticles are present in an amount sufficient to increase material throughput relative to a comparable dispersion that is free of nanoparticles.

3. The method of claim 1, wherein the nanoparticles are present in an amount sufficient to decrease mixing time relative to a comparable dispersion that is free of nanoparticles.

4. The method of claim 1, wherein the nanoparticles are present in an amount sufficient to increase the homogeneity of the dispersion relative to a comparable dispersion that is free of nanoparticles.

5. The method of claim 1, wherein the nanoparticles are present in an amount sufficient to increase the weight percent of the microparticles in the dispersion relative to a comparable dispersion that is free of nanoparticles.

6. The method of claim 1, wherein the nanoparticles are present in an amount sufficient to increase the volume percent of the microparticles in the dispersion relative to a comparable dispersion that is free of nanoparticles.

7. The method of claim 1, wherein the microparticles are selected from the group consisting of fillers, extenders, ceramic beads, ceramic bubbles, ceramic microspheres, pigments, and combinations thereof.

8. The method of claim 1, wherein the microparticles are inorganic pigments

9. The method of claim 1, wherein the microparticles are calcium carbonate.

10. The method of claim 1, wherein the microparticles have a median particle size diameter greater than 0.5 micrometer.

11. The method of claim 1, wherein the nanoparticles are selected from the group consisting of silica, titania, alumina, nickel oxide, zirconia, vanadia, ceria, iron oxide, antimony oxide, tin oxide, zinc oxide, calcium phosphate, calcium hydroxyapatite, calcium carbonate and combinations thereof.

12. The method of claim 1, wherein the nanoparticles are surface modified.

13. The method of claim 1, wherein the nanoparticles are isooctyl functionalized silica nanoparticles.

14. The method of claim 1, wherein the nanoparticles are dispersed within the microparticles.

15. The method of claim 1, wherein the weight ratio of the nanoparticles to the microparticles is at least 1:100,000.

16. The method of claim 1, wherein the nanoparticles are present at a concentration of at least 0.00075 weight percent, based on the total weight of the dispersion.

17. A dispersion comprising microparticles, nanoparticles, and an asphalt component, wherein the nanoparticles are present in an amount sufficient to increase material throughput relative to a comparable dispersion that is free of nanoparticles.

18. The method of claim 17, wherein the nanoparticles are present in an amount sufficient to decrease mixing time relative to a comparable dispersion that is free of nanoparticles.

19. The dispersion of claim 17, wherein the nanoparticles are present in an amount sufficient to increase the homogeneity of the dispersion relative to a comparable dispersion that is free of nanoparticles.

20. The dispersion of claim 17, wherein the nanoparticles are present in an amount sufficient to increase the weight percent of the microparticles in the dispersion relative to a comparable dispersion that is free of nanoparticles.

21. The method of claim 1, wherein the nanoparticles are present in an amount sufficient to increase the volume percent of the microparticles in the dispersion relative to a comparable dispersion that is free of nanoparticles.

22. The dispersion of claim 17, wherein the microparticles comprise pigments.

23. The dispersion of claim 17, wherein the microparticles comprise calcium carbonate.

24. A composition comprising the dispersion of claim 17, further comprising a curable component.
